(19) United States
(12) Patent Application Publication
(10) Pub. No.: US 2020/0010066 A1
(43) Pub. Date: Jan. 9, 2020

(54) Abnormality Diagnostic Device and Abnormality Diagnostic Method for Booster

(71) Applicant: Hitachi Automotive Systems, Ltd., Hitachinaka-shi, Ibaraki (JP)

(72) Inventor: Koichi FUJISAKI, Isesaki-shi (JP)

(21) Appl. No.: 16/491,070

(22) PCT Filed: Feb. 28, 2018
(86) PCT No.: PCT/JP2018/007472

§ 371 Date: Sep. 4, 2019

(30) Foreign Application Priority Data
Mar. 6, 2017 (JP) 2017-041676

(51) Int. Cl. B60T 13/66; B60T 17/02; B60T 17/22

(52) U.S. Cl. CPC B60T 13/662; F02D 2250/41; B60T 17/221; B60T 17/02

(57) ABSTRACT

An abnormality diagnostic device and an abnormality diagnostic method for a booster according to the present invention: determine that a negative pressure sensor operates normally, when an output of the negative pressure sensor changes in response to a decrease in intake pressure; determine that a negative pressure pump operates normally, when the pressure in a negative pressure chamber is decreased by operating the negative pressure pump, and the pressure decrease is determined by the negative pressure sensor determined to be normal; determine that the negative pressure pump is abnormal when the pressure decrease is not determined by the negative pressure sensor; and determine that a negative pressure leakage has occurred, when the pressure in the negative pressure chamber, which has been decreased by the negative pressure pump, is not maintained.

### TECHNICAL FIELD

The present invention relates to abnormality diagnostic devices and abnormality diagnostic methods for determining whether there is an abnormality in a negative pressure pump that generates a negative pressure and a pressure sensor that measures the pressure in a negative pressure chamber in a booster that boosts a brake operating force by a negative pressure in the negative pressure chamber.

### BACKGROUND ART

Patent Document 1 discloses a negative pressure system including: a negative pressure pump that generates a negative pressure by driving an actuator; a negative pressure type booster that is connected to the negative pressure pump and boosts an operation input to a brake pedal; pressure measuring means that is connected to a negative pressure chamber of the negative pressure type booster, and measures the pressure in the negative pressure chamber; and abnormality determining means for determining an abnormality of the pressure measuring means based on an operation time or an operation state of the actuator, and a measured value of the pressure measuring means.

### REFERENCE DOCUMENT LIST

### Patent Document

Patent Document 1: JP 2012-214185 A

### SUMMARY OF THE INVENTION

### Problem to be Solved by the Invention

There may be a case in which, even when a pressure sensor for measuring the pressure in the negative pressure chamber of the booster operates normally, the measured value of the pressure sensor becomes an abnormal value due to an abnormality in the negative pressure pump for making the negative pressure introduced into the negative pressure chamber.

Furthermore, when an abnormality occurs in the negative pressure pump, and if the normally operating pressure sensor is erroneously determined to be abnormal, processing adapted to the abnormal state of the abnormal pattern cannot be optimally performed. Furthermore, if the normally operating pressure sensor is replaced when performing maintenance based on erroneous abnormality diagnosis information, such maintenance repair cannot restore it to a normal state. Thus, maintenance cannot be performed accurately and efficiently, resulting in problems in that maintenance takes longer or normal parts are erroneously replaced.

The present invention has been made in view of these problems, and an object of the present invention is to provide an abnormality diagnostic device and an abnormality diagnostic method capable of performing a diagnosis, distinguishing an abnormality occurring in a negative pressure pump and an abnormality occurring in a pressure sensor.

### Means for Solving the Problem

According to an aspect of the present invention, there is provided an abnormality diagnostic device for a booster including: a negative pressure pump that generates a negative pressure; a negative pressure chamber into which the negative pressure generated by the negative pressure pump and an intake pipe negative pressure of an internal combustion engine are introduced; and a pressure sensor that measures a pressure in the negative pressure chamber, the booster boosting a brake operating force by a negative pressure in the negative pressure chamber,

the abnormality diagnostic device comprising:

a first determining unit configured to determine a change in a measured pressure value obtained by the pressure sensor, in a state in which the negative pressure pump is stopped;

a second determining unit configured to determine a change in a measured pressure value obtained by the pressure sensor, in a state in which the negative pressure pump is operated; and

a diagnosing unit configured to receive a determination result of the first determining unit and a determination result of the second determining unit, to generate abnormality diagnostic information for each of the negative pressure pump and the pressure sensor.

Furthermore, according to an aspect of the present invention, there is provided an abnormality diagnostic method for a booster including: a negative pressure pump that generates a negative pressure; a negative pressure chamber into which the negative pressure generated by the negative pressure pump and an intake pipe negative pressure of an internal combustion engine are introduced; and a pressure sensor that measures a pressure in the negative pressure chamber, the booster boosting a brake operating force by a negative pressure in the negative pressure chamber,

the abnormality diagnostic method comprising:

a first step of determine a change in a measured pressure value obtained by the pressure sensor, in a state in which the negative pressure pump is stopped and in a condition in which the pressure in the negative pressure chamber decreases due to the intake pipe negative pressure of the internal combustion engine;

a second step of determining a change in a measured pressure value obtained by the pressure sensor, in a state in which the negative pressure pump is operated and in a condition in which the pressure in the negative pressure chamber decreases due to the negative pressure generated by the negative pressure pump; and

a third step of receiving the change in the measured pressure value determined in the first step and the change in the measure pressure value determined in the second step, to generate abnormality diagnostic information for each of the negative pressure pump and the pressure sensor.

### Effects of the Invention

According to the invention, since the abnormality diagnostic information distinguishing between the abnormality of the negative pressure pump and the abnormality of the pressure sensor is generated, it is possible to perform the appropriate processing adapted to the abnormal portion when an abnormality occurs in the booster, and furthermore, it is possible to perform maintenance accurately and efficiently.

### BRIEF DESCRIPTION OF THE DRAWINGS

FIG. 1 is a system configuration diagram of a booster according to an embodiment of the present invention.

FIG. 2 is a timing chart for explaining an example of a diagnosis with a negative pressure pump stopped, according to the embodiment of the present invention.

FIG. 3 is a timing chart for explaining an example of a diagnosis with the negative pressure pump operated, according to the embodiment of the present invention.

FIG. 4 is a timing chart for explaining an example of a diagnosis of a brake negative pressure system (negative pressure leakage diagnosis) according to the embodiment of the present invention.

FIG. 5 is a diagram illustrating an example of an execution pattern of diagnostic processes in the embodiment of the present invention.

FIG. 6 is a timing chart for explaining an example of the diagnosis with the negative pressure pump operated and the diagnosis with the negative pressure pump stopped, according to the embodiment of the present invention.

FIG. 7 is a timing chart for explaining an example of the diagnosis with the negative pressure pump operated and the diagnosis with the negative pressure pump stopped, according to the embodiment of the present invention.

FIG. 8 is a table illustrating determination characteristics of normality and abnormality in the diagnosis with the negative pressure pump operated and the diagnosis with the negative pressure pump stopped, according to the embodiment of the present invention.

FIG. 9 is a diagram illustrating an example of an execution pattern of diagnostic processes according to the embodiment of the present invention.

FIG. 10 is a timing chart for explaining the diagnosis with the negative pressure pump stopped at the time of fuel cut, according to the embodiment of the present invention.

FIG. 11 is a table illustrating determination characteristics of normality and abnormality in the diagnosis with the negative pressure pump stopped, according to the embodiment of the present invention.

FIG. 12 is a timing chart for explaining the diagnosis with the negative pressure pump operated during an idle reduction, according to the embodiment of the present invention.

FIG. 13 is a timing chart for explaining the diagnosis with the negative pressure pump operated and the diagnosis with the negative pressure pump stopped, when an internal combustion engine is restarted from the idle reduction state, according to the embodiment of the present invention.

FIG. 14 is a table illustrating determination characteristics of normality and abnormality in the diagnosis of the brake negative pressure system, according to the embodiment of the present invention.

FIG. 15 is a timing chart for explaining the diagnosis of the brake negative pressure system during coasting, according to the embodiment of the present invention.

FIG. 16 is a flowchart illustrating the procedure of an initial sensor diagnosis, the diagnosis with the negative pressure pump operated, the diagnosis with the negative pressure pump stopped, and the diagnosis of the brake negative pressure system, according to the embodiment of the present invention.

FIG. 17 is a flowchart illustrating the procedure of the initial sensor diagnosis, according to the embodiment of the present invention.

FIG. 18 is a flowchart illustrating the procedure of the diagnosis with the negative pressure pump stopped, according to the embodiment of the present invention.

FIG. 19 is a flowchart illustrating the procedure of the diagnosis with the negative pressure pump operated, according to the embodiment of the present invention.

FIG. 20 is a flowchart illustrating the procedure of diagnosis of the brake negative pressure system, according to the embodiment of the present invention.

### MODE FOR CARRYING OUT THE INVENTION

Hereinbelow, embodiments of the present invention will be described.

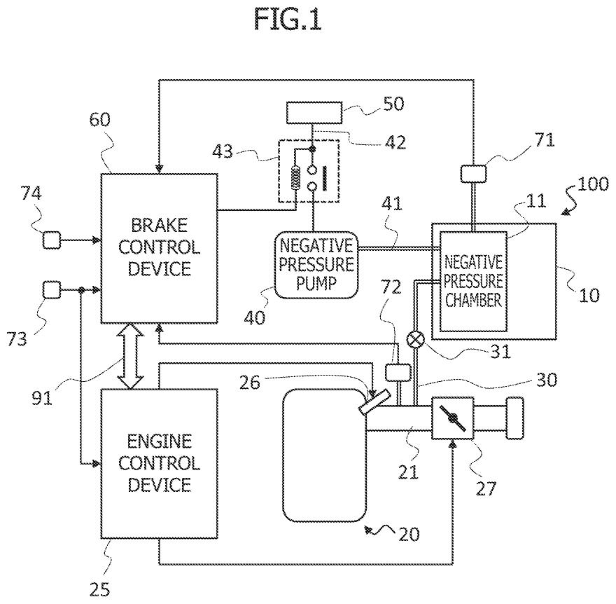

FIG. 1 is a configuration block diagram illustrating an aspect of a booster according to the present invention.

A booster 100 illustrated in FIG. 1 constitutes a hydraulic brake for a vehicle. A vacuum servo 10 boosts a driver's brake operating force utilizing a negative pressure.

In addition to vacuum servo 10 having a negative pressure chamber 11, booster 100 includes, for example, a negative pressure pump 40, and a negative pressure sensor 71 that measures the pressure in negative pressure chamber 11.

A first negative pressure pipe 30 provides communication between negative pressure chamber 11 of vacuum servo 10, and an intake manifold 21, which is an intake pipe downstream of an electronically controlled throttle 27.

First negative pressure pipe 30 is provided with a check valve 31. Check valve 31 opens when the pressure in intake manifold 21 is lower than the pressure in negative pressure chamber 11 by a predetermined amount or more, so as to introduce a throttle negative pressure, which is a negative pressure in intake manifold 21, into negative pressure chamber 11.

Furthermore, electric negative pressure pump 40 is connected to negative pressure chamber 11 through a second negative pressure pipe 41, and a negative pressure generated by negative pressure pump 40 is introduced into negative pressure chamber 11 through second negative pressure pipe 41.

A power supply relay 43 is provided on a power supply line 42 for supplying electric power from a battery 50 to negative pressure pump 40. When power supply relay 43 is turned on, negative pressure pump 40 is supplied with power to actuate negative pressure pump 40, and negative pressure pump 40 generates a negative pressure. On the other hand, when power supply relay 43 is turned off, the power supply to negative pressure pump 40 is shut off, so that negative pressure pump 40 stops generating the negative pressure.

A brake control device 60, which is an electronic control device provided with a microcomputer including a processor, a memory, and the like, controls on and off of power supply relay 43.

Brake control device 60 receives an output signal of negative pressure sensor 71, and also receives an output signal of an intake pressure sensor 72 that measures the intake pressure, which is the pressure in intake manifold 21.

When the pressure in negative pressure chamber 11 measured by negative pressure sensor 71 is higher than a set negative pressure, that is, when the pressure is on the positive pressure side with respect to the set negative pressure, brake control device 60 turns on power supply relay 43 to actuate negative pressure pump 40, and makes a negative pressure generated by negative pressure pump 40 be introduced into negative pressure chamber 11, so as to maintain the pressure in negative pressure chamber 11 to be lower than the set negative pressure.

Brake control device 60 also receives signals, such as a signal indicating an operated position of an ignition switch 73, which is a main switch for driving and stopping an internal combustion engine 20, and an on-and-off signal of a brake switch 74 for determining whether the driver operated the brake, as well as the output signals of negative pressure sensor 71 and intake pressure sensor 72.

Brake control device 60 is configured to be capable of two-way communication with an engine control device 25 that controls internal combustion engine 20, via a controller area network (CAN) 91.

Engine control device 25 is an electronic control device provided with a microcomputer including a processor, a memory, and the like.

Engine control device 25 has software functions, such as a function of controlling a fuel injection amount of a fuel injection valve 26 that supplies fuel to internal combustion engine 20, and a function of controlling an opening degree of electronically controlled throttle 27 that adjusts an intake air amount of internal combustion engine 20.

Engine control device 25 also has, as software, a function of stopping fuel injection performed by fuel injection valve 26 in a predetermined deceleration operation state of internal combustion engine 20, a function of automatically stopping the operation of internal combustion engine 20 when the vehicle is waiting for a traffic light or the vehicle is stopped or parked, and the like.

Engine control device 25 transmits, to brake control device 60 via CAN 91, information indicating whether fuel cut processing, which stops injecting fuel in a deceleration operation of internal combustion engine 20, and idle reduction processing, which automatically stops internal combustion engine 20, are carried out.

On the other hand, brake control device 60 has a function, as software, of determining whether there is an abnormality in booster 100, that is, a function of generating abnormality diagnostic information on booster 100, as well as the abovementioned function of controlling turning on and off of power supply relay 43.

Brake control device 60 performs three diagnoses as an abnormality diagnosis of booster 100: a diagnosis with the negative pressure pump stopped, a diagnosis with the negative pressure pump operated, and a diagnosis of the brake negative pressure system. Brake control device 60 distinguishes between an abnormality of negative pressure sensor 71, an abnormality of negative pressure pump 40, and an abnormality of the brake negative pressure system.

That is, brake control device 60 has a function serving as a diagnosing unit that generates abnormality diagnostic information for each of negative pressure pump 40 and negative pressure sensor 71.

The diagnosis with the negative pressure pump stopped is the processing in which a change in a measured pressure value obtained by negative pressure sensor 71 is monitored in a state in which negative pressure pump 40 is stopped and in a condition in which the pressure in negative pressure chamber 11 decreases due to the intake negative pressure introduced into negative pressure chamber 11, and it is determined whether the measured pressure value obtained by negative pressure sensor 71 changes following a change in intake pressure.

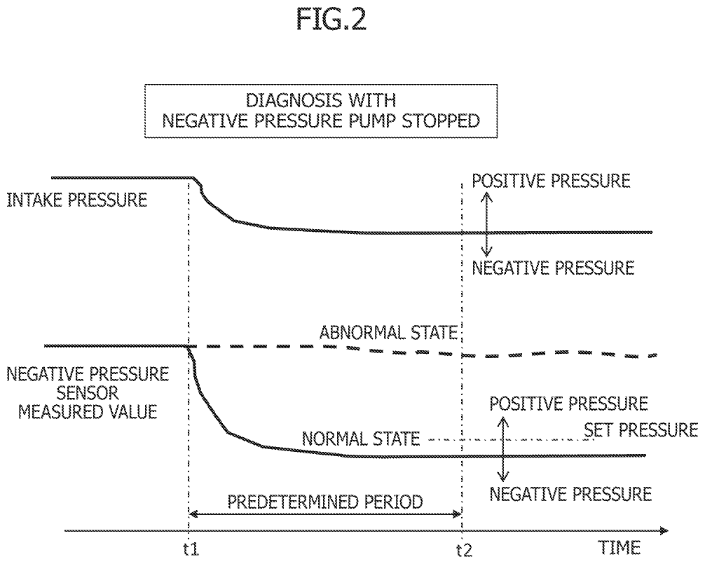

FIG. 2 illustrates the relationship between the change in intake pressure and the measured pressure value obtained by negative pressure sensor 71 in the diagnosis with the negative pressure pump stopped.

As the diagnosis with the negative pressure pump stopped, brake control device 60 monitors the measured pressure value obtained by negative pressure sensor 71 in, for example, coasting, which is a deceleration state in which the brake is not operated.

That is, brake control device 60 has a function serving as a first determining unit that is configured to determine a change in measured pressure value obtained by negative pressure sensor 71, in a state in which negative pressure pump 40 is stopped.

Here, if the measured pressure value obtained by negative pressure sensor 71 does not change in the condition in which the pressure in negative pressure chamber 11 decreases as the intake pressure decreases, there is a possibility that an abnormality that the change in the output of negative pressure sensor 71 does not correspond to the actual pressure change, and/or an abnormality that the intake negative pressure is not introduced into negative pressure chamber 11 will occur.

On the other hand, if the measured pressure value obtained by negative pressure sensor 71 changes following the change in pressure in the condition in which the pressure in negative pressure chamber 11 decreases as the intake pressure decreases, the intake negative pressure is introduced into negative pressure chamber 11, and the change in the output of negative pressure sensor 71 corresponds to the actual pressure change.

In the diagnosis with the negative pressure pump stopped, when monitoring a decrease in pressure in negative pressure chamber 11 due to the introduction of the intake negative pressure, brake control device 60 may employ a condition for performing the diagnosis, in which the intake pressure and the pressure in negative pressure chamber 11 are controlled to be a positive pressure, and then the pressure in negative pressure chamber 11 decreases from this positive pressure state due to the introduction of the intake negative pressure. This results in accurate monitoring of the pressure decrease caused by the introduction of the intake negative pressure.

Furthermore, as the diagnosis with the negative pressure pump operated, brake control device 60 operates negative pressure pump 40 for a predetermined time period to make the negative pressure generated by negative pressure pump 40 introduced into negative pressure chamber 11, when the pressure in intake manifold 21 is positive and check valve 31 is closed. At this time, brake control device 60 monitors the change in the measured pressure value obtained by negative pressure sensor 71 (second determining unit), and determines whether negative pressure sensor 71 determines a pressure change corresponding to the operation of negative pressure pump 40.

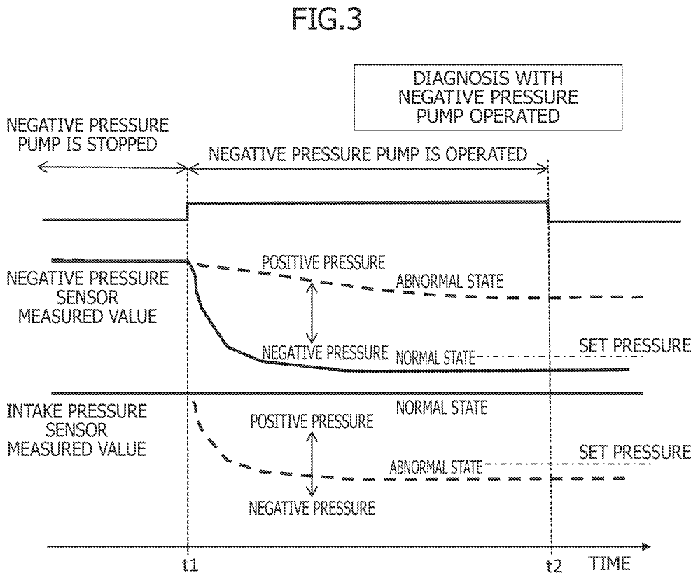

FIG. 3 illustrates a change in the measured pressure value obtained by negative pressure sensor 71 in the diagnosis with the negative pressure pump operated.

Brake control device 60 has a function serving as a second determining unit that is configured to operate negative pressure pump 40 from time t1 to time t2 in FIG. 3, and to determine the change in the measured pressure value obtained by negative pressure sensor 71 in the state in which negative pressure pump 40 is operated.

In the diagnosis with the negative pressure pump stopped, if the measured pressure value obtained by negative pressure sensor 71 does not follow the decrease in the intake negative pressure, as indicated by a broken line in FIG. 2, there is a possibility of an abnormality of negative pressure sensor 71 that the change in the output of negative pressure sensor 71 does not correspond to the actual pressure change, and/or an abnormality that the intake negative pressure fails to be introduced into negative pressure chamber 11 due to an abnormality of the brake negative pressure system, such as fixation of check valve 31 in the closed state, so that the actual pressure in negative pressure chamber 11 does not change in synchronization with the intake negative pressure.

On the other hand, in the diagnosis with the negative pressure pump operated, if negative pressure pump 40 is operated for a predetermined time period and the measured pressure value obtained by negative pressure sensor 71 decreases to a set pressure (see FIG. 3), it is determined that at least negative pressure sensor 71 operates normally.

Thus, when brake control device 60 determines that the measured pressure value obtained by negative pressure sensor 71 does not follow the intake negative pressure in the diagnosis with the negative pressure pump stopped, and determines that the measured pressure value obtained by negative pressure sensor 71 decreases to the set pressure in the diagnosis with the negative pressure pump operated, brake control device 60 determines that there has been occurred an abnormality of the brake negative pressure system that the intake negative pressure fails to be introduced into negative pressure chamber 11, that is, check valve 31 is fixed to be closed.

Furthermore, in the diagnosis with the negative pressure pump operated, if negative pressure pump 40 is operated for the predetermined time period and the measured pressure value obtained by negative pressure sensor 71 does not decrease to the set pressure (see FIG. 3), there is a possibility that an abnormality of negative pressure sensor 71 and/or an abnormality of negative pressure pump 40 has occurred.

Here, if the measured pressure value obtained by negative pressure sensor 71 does not decrease to the set pressure in the diagnosis with the negative pressure pump operated and the measured pressure value obtained by negative pressure sensor 71 does not follow the intake negative pressure in the diagnosis with the negative pressure pump stopped, this indicates a state in which the output from negative pressure sensor 71 does not change in the expected manner in both of a state in which the negative pressure generated by negative pressure pump 40 is introduced into negative pressure chamber 11 and a state in which the intake negative pressure is introduced into negative pressure chamber 11. Thus, brake control device 60 determines that negative pressure sensor 71 is abnormal.

On the other hand, if brake control device 60 determines that the measured pressure value obtained by negative pressure sensor 71 follows the intake negative pressure in the diagnosis with the negative pressure pump stopped, brake control device 60 determines that at least negative pressure sensor 71 operates normally.

When brake control device 60 determines that negative pressure sensor 71 operates normally in the diagnosis with the negative pressure pump stopped, and if brake control device 60 determines that there has occurred an abnormality that the measured pressure value obtained by negative pressure sensor 71 does not decrease to the set pressure in the diagnosis with the negative pressure pump operated, brake control device 60 determines that the actual pressure in negative pressure chamber 11 does not decrease to the set pressure due to an abnormality of negative pressure pump 40.

Furthermore, when a measured value of the intake pressure obtained by intake pressure sensor 72 decreases toward a negative pressure side in the diagnosis with the negative pressure pump operated, as illustrated in FIG. 3, brake control device 60 determines that the negative pressure generated by negative pressure pump 40 is introduced into intake manifold 21 because, for example, check valve 31 is fixed to be open, so that brake control device 60 determines that the brake negative pressure system is abnormal, that is, check valve 31 is fixed to be open.

The diagnosis of the brake negative pressure system determines whether the negative pressure in negative pressure chamber 11 can be maintained.

Brake control device 60 has a function serving as a third determining unit that is configured to monitor the measured pressure value obtained by negative pressure sensor 71, when the intake pressure is positive in the state in which negative pressure pump 40 is stopped after the pressure in negative pressure chamber 11 has decreased to the set negative pressure due to the drive of negative pressure pump 40 or due to the intake negative pressure.

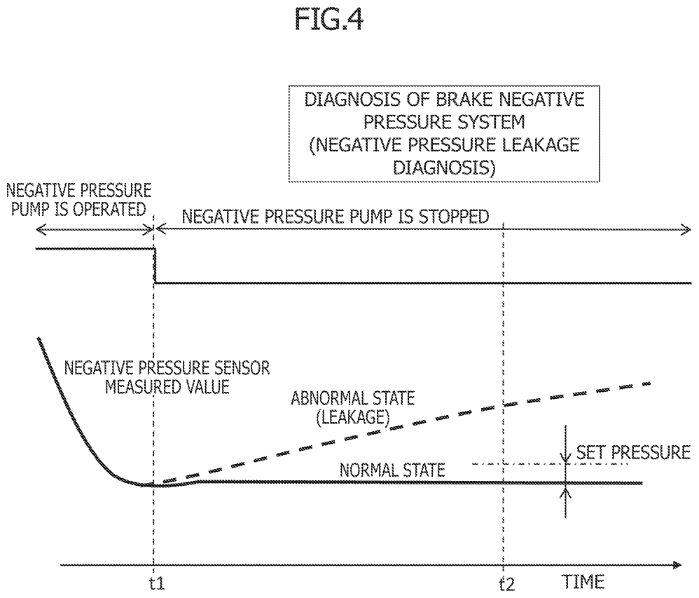

As illustrated in FIG. 4, if an amount of change in the measured pressure value obtained by negative pressure sensor 71 in a predetermined time period exceeds a set value, that is, if the pressure in negative pressure chamber 11 increases toward the positive pressure side by a threshold or more in the predetermined time period, brake control device 60 determines that the brake negative pressure system is abnormal, and more specifically, determines that a negative pressure leakage from negative pressure chamber 11 has occurred.

Here, brake control device 60 may execute the diagnosis with the negative pressure pump stopped, the diagnosis with the negative pressure pump operated, and the diagnosis of the brake negative pressure system, in a freely selected order.

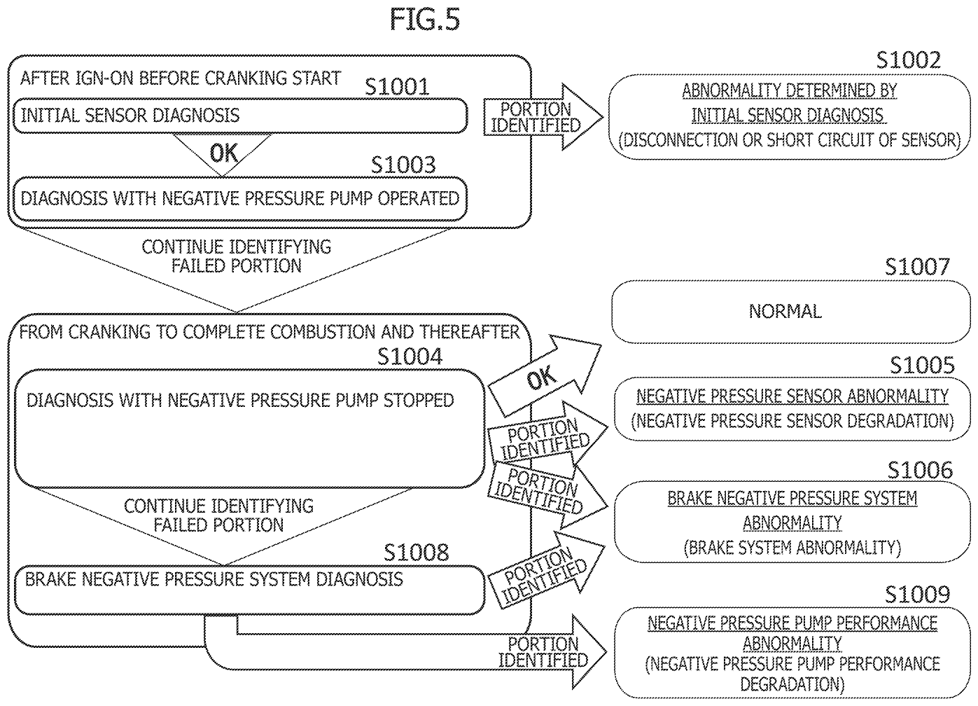

FIG. 5 illustrates an aspect of a diagnosing pattern in a case in which brake control device 60 executes an initial sensor diagnosis that diagnoses whether there is a disconnection or a short circuit of an output line of the measurement output of negative pressure sensor 71, together with the diagnosis with the negative pressure pump stopped, the diagnosis with the negative pressure pump operated, the diagnosis of the brake negative pressure system.

In the diagnosing pattern illustrated in FIG. 5, the initial sensor diagnosis and the diagnosis with the negative pressure pump operated are executed in this order in a period from the power-on to the start of startup (cranking) of internal combustion engine 20, and the diagnosis with the negative pressure pump stopped and the diagnosis of the brake negative pressure system are executed in this order in a period from the start of startup (cranking) of internal combustion engine 20 to the completion of startup (complete combustion).

That is, when brake control device 60 is started up by supplying power to booster 100 including brake control device 60, brake control device 60 reads the measurement output of negative pressure sensor 71 before the cranking of internal combustion engine 20 starts, and executes the initial sensor diagnosis (step S1001) that determines whether an abnormality, such as a disconnection or a short circuit, has occurred in the signal line of negative pressure sensor 71.

Here, brake control device 60 may determine that a disconnection or a short circuit has occurred by determining whether the output signal of negative pressure sensor 71 is within a predetermined normal range.

That is, an output range that corresponds to a variable range of the pressure in negative pressure chamber 11 is adapted in advance to the normal range such that the output signal of negative pressure sensor 71 falls within the normal range when negative pressure sensor 71 outputs a signal corresponding to an actual pressure in negative pressure chamber 11, and the normal range is stored in advance in brake control device 60.

If the output signal of negative pressure sensor 71 is within the normal range, brake control device 60 determines that no disconnection and no short circuit has occurred, whereas if the output signal of negative pressure sensor 71 is outside the normal range, brake control device 60 determines that a disconnection or a short circuit has occurred (step S1002).

When brake control device 60 determines that no disconnection and no short circuit has occurred in negative pressure sensor 71 in the initial sensor diagnosis, then brake control device 60 performs the diagnosis in which a change in the measured pressure value obtained by negative pressure sensor 71 at the time when negative pressure pump 40 is operated for a predetermined time period before starting up internal combustion engine 20, is monitored (step S1003).

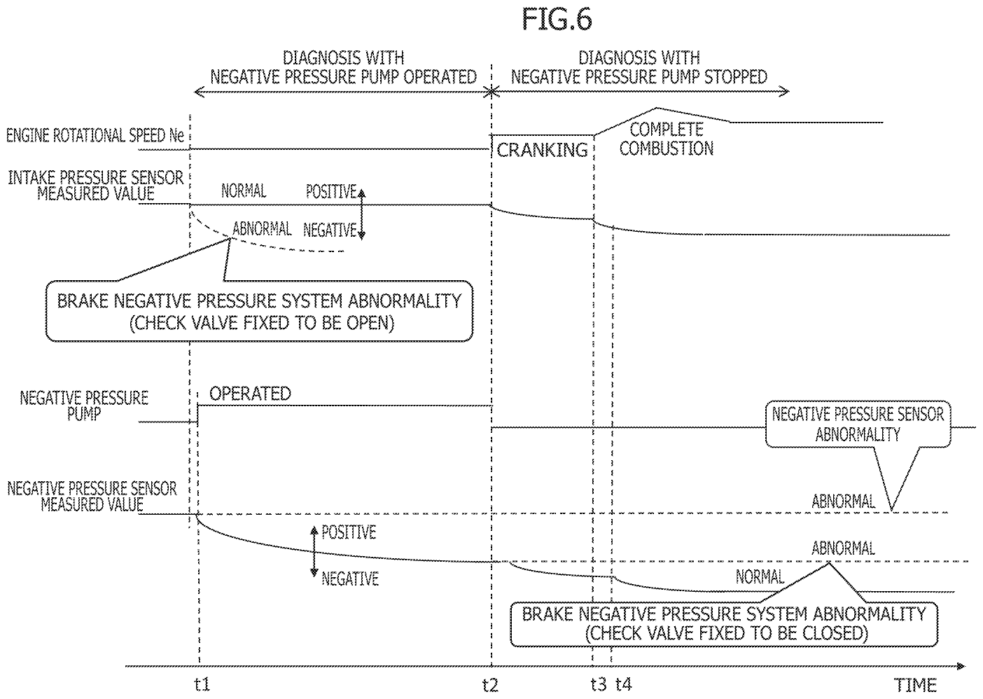

If negative pressure pump 40 and negative pressure sensor 71 operate normally when negative pressure pump 40 is operated before starting up internal combustion engine 20, the negative pressure generated by negative pressure pump 40 is introduced into negative pressure chamber 11 because the intake pressure is positive, so that the measured pressure value of negative pressure sensor 71 decreases as illustrated in FIG. 6. Brake control device 60 stores a determination result indicating whether the measured pressure value of negative pressure sensor 71 decreases to the set pressure in the predetermined time period.

Before starting the startup of internal combustion engine 20, intake pressure sensor 72 for measuring the pressure in intake manifold 21 outputs a signal indicating that the pressure is positive in a normal state. If the output of intake pressure sensor 72 decreases toward the negative pressure side in the state in which negative pressure pump 40 is operated, as illustrated by a broken line in FIG. 6, brake control device 60 determines that the negative pressure generated by negative pressure pump 40 is introduced into intake manifold 21 via negative pressure chamber 11, that is, check valve 31 is fixed to be open, as the diagnosis of the brake negative pressure system.

Since brake control device 60 cannot identify the failed portion only by the measured pressure value of negative pressure sensor 71 monitored in the diagnosis with the negative pressure pump operated, brake control device 60 makes internal combustion engine 20 start up in a state in which negative pressure pump 40 is stopped. When the startup of internal combustion engine 20 starts, brake control device 60 performs the diagnosis with the negative pressure pump stopped (step S1004).

When the startup of internal combustion engine 20 starts and the intake negative pressure develops, the intake negative pressure is introduced into negative pressure chamber 11, resulting in a further pressure decrease in negative pressure chamber 11, as illustrated in FIG. 6. Brake control device 60 monitors the change in the measured pressure value obtained by negative pressure sensor 71 at this time.

Then, if the output of negative pressure sensor 71 does not change even in a state in which the negative pressure generated by negative pressure pump 40 be introduced into negative pressure chamber 11 in the operated state of negative pressure pump 40, and furthermore, if the output of negative pressure sensor 71 does not change even in a state in which the intake negative pressure be introduced into negative pressure chamber 11 in the stopped state of negative pressure pump 40, then brake control device 60 determines that negative pressure sensor 71 is abnormal (step S1005).

Furthermore, if the output of negative pressure sensor 71 changes in a desired manner in a state in which the negative pressure generated by negative pressure pump 40 be introduced into negative pressure chamber 11 in the operated state of negative pressure pump 40, and if the output of negative pressure sensor 71 does not change even in a state in which the intake negative pressure be introduced into negative pressure chamber 11 in the stopped state of negative pressure pump 40, then brake control device 60 determines that there has been occurred an abnormality that the intake negative pressure fails to be introduced into negative pressure chamber 11, that is, check valve 31 is fixed to be closed (step S1006).

If the output of negative pressure sensor 71 changes in a desired manner in a state in which the negative pressure generated by negative pressure pump 40 be introduced into negative pressure chamber 11 in the operated state of negative pressure pump 40, and if the output of negative pressure sensor 71 changes in a desired manner in a state in which the intake negative pressure be introduced into negative pressure chamber 11 in the stopped state of negative pressure pump 40, then brake control device 60 determines that negative pressure pump 40 and negative pressure sensor 71 operate normally (step S1007).

On the other hand, if the output of negative pressure sensor 71 does not change even in a state in which the negative pressure generated by negative pressure pump 40 be introduced into negative pressure chamber 11 in the operated state of negative pressure pump 40, and if the output of negative pressure sensor 71 changes in a desired manner in a state in which the intake negative pressure be introduced into negative pressure chamber 11 in the stopped state of negative pressure pump 40, then brake control device 60 performs the diagnosis of the brake negative pressure system (step S1008).

Then, if the measure pressure value obtained by negative pressure sensor 71 increases by a predetermined amount or more in a predetermined time period even in a condition in which the negative pressure be confined in negative pressure chamber 11, brake control device 60 determines that a leakage of the negative pressure from negative pressure chamber 11 has occurred, that is, the brake negative pressure system is abnormal (step S1006).

Here, in the diagnosis of the brake negative pressure system, brake control device 60 may operate negative pressure pump 40 to decrease the pressure in negative pressure chamber 11 to the set negative pressure, and monitor the subsequent change in pressure in the stopped state of negative pressure pump 40. If the pressure in negative pressure chamber 11 does not decrease to the set negative pressure in the process of operating negative pressure pump 40 to decrease the pressure in negative pressure chamber 11 to the set negative pressure, brake control device 60 may determine that negative pressure pump 40 is abnormal (step S1009).

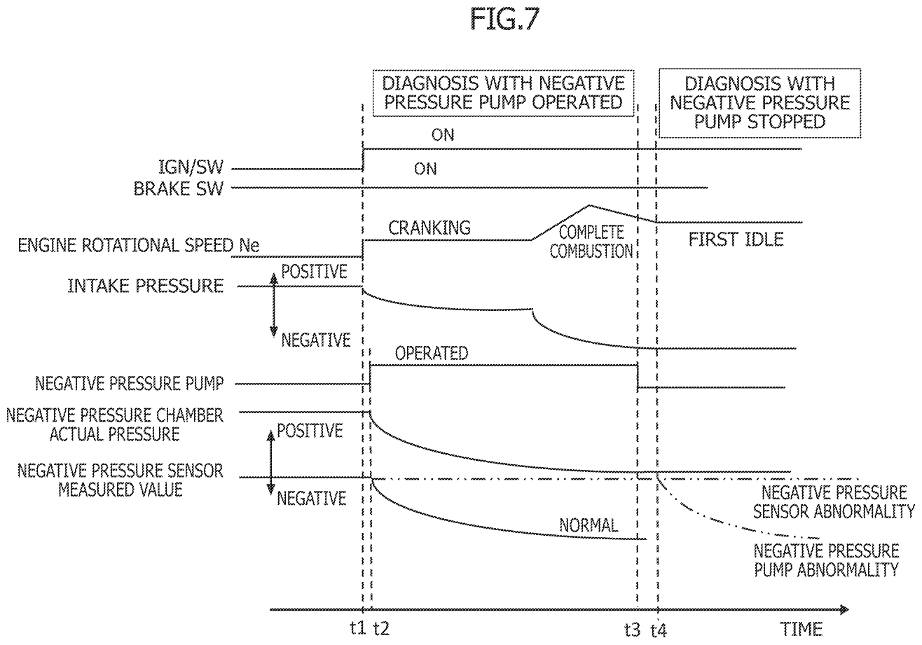

Although, in the diagnosing pattern in FIG. 5, brake control device 60 performs the diagnosis with the negative pressure pump operated before starting the startup of internal combustion engine 20, brake control device 60 may perform the diagnosis with the negative pressure pump operated during cranking and then perform the diagnosis with the negative pressure pump stopped after the complete combustion, as illustrated in FIG. 7.

As illustrated in FIG. 7, brake control device 60 operates negative pressure pump 40 in a period from the start of cranking (time t1 in FIG. 7) to the first idle (time t4 in FIG. 7), i.e., operated from time t2 to time t3 in FIG. 7, and performs the diagnosis with the negative pressure pump operated, in which it is monitored whether the measured pressure value obtained by negative pressure sensor 71 changes to the set negative pressure in the operated period of negative pressure pump 40.

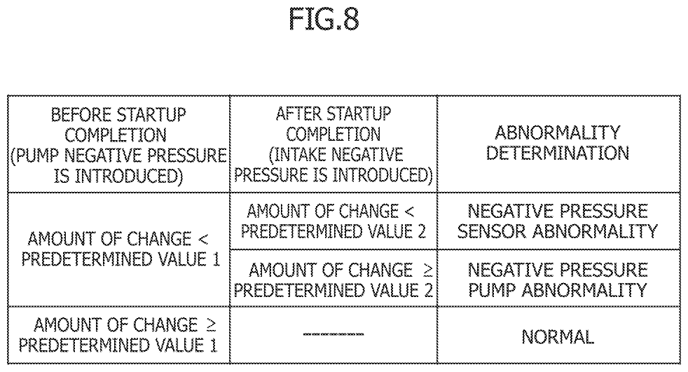

If an amount of change in the measured pressure value obtained by negative pressure sensor 71 during the operated period of negative pressure pump 40 is greater than or equal to a first predetermined value, brake control device 60 determines that negative pressure pump 40 and negative pressure sensor 71 operate normally (see FIG. 8).

On the other hand, if the amount of change in the measured pressure value obtained by negative pressure sensor 71 during the operated period of negative pressure pump 40 is less than the first predetermined value, brake control device 60 performs the diagnosis with the negative pressure pump stopped, after startup of the internal combustion engine, to identify which of negative pressure pump 40 and negative pressure sensor 71 is abnormal.

That is, brake control device 60 stops negative pressure pump 40 to introduce the intake negative pressure into negative pressure chamber 11 in the first idle state (after time t4 in FIG. 7) after the complete combustion, and performs the diagnosis with the negative pressure pump stopped.

In the condition in which the pressure in negative pressure chamber 11 decreases due to the intake negative pressure introduced into negative pressure chamber 11, brake control device 60 obtains an amount of change in the measured pressure value obtained by negative pressure sensor 71 decreasing toward the negative pressure side in a predetermined time period.

Then, if the amount of change in the measured pressure value obtained in the diagnosis with the negative pressure pump stopped is greater than or equal to a second predetermined value, brake control device 60 determines that negative pressure sensor 71 operates normally and the result of the diagnosis with negative pressure pump operated indicating the abnormality is due to a performance degradation abnormality of negative pressure pump 40. If the amount of change in the measured pressure value obtained in the diagnosis with the negative pressure pump stopped decreases below the second predetermined value, that is, if the measured pressure value of negative pressure sensor 71 does not change in response in both diagnoses with the negative pressure pump operated and stopped, brake control device 60 determines that the result of the diagnosis with the negative pressure pump operated indicating the abnormality is due to abnormal negative pressure sensor 71 (see FIG. 8).

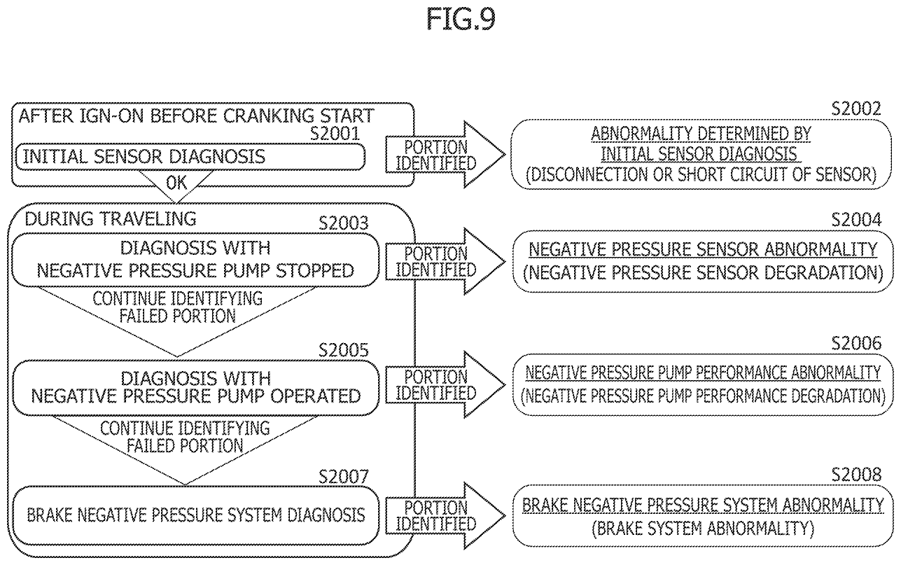

FIG. 9 illustrates another aspect of the diagnosing pattern for performing the diagnosis with the negative pressure pump stopped, the diagnosis with the negative pressure pump operated, the diagnosis of the brake negative pressure system, and the initial sensor diagnosis.

In the diagnosing pattern in FIG. 9, brake control device 60 performs the initial sensor diagnosis in a period from the power-on to the start of startup of internal combustion engine 20 (step S2001), and then, if the output of negative pressure sensor 71 is outside the normal range, brake control device 60 determines that there is a disconnection or a short circuit in negative pressure sensor 71 (step S2002).

On the other hand, when there is no disconnection and no short circuit in negative pressure sensor 71, first, brake control device 60 performs the diagnosis with the negative pressure pump stopped during traveling of the vehicle after completion of the startup of internal combustion engine 20 (step S2003).

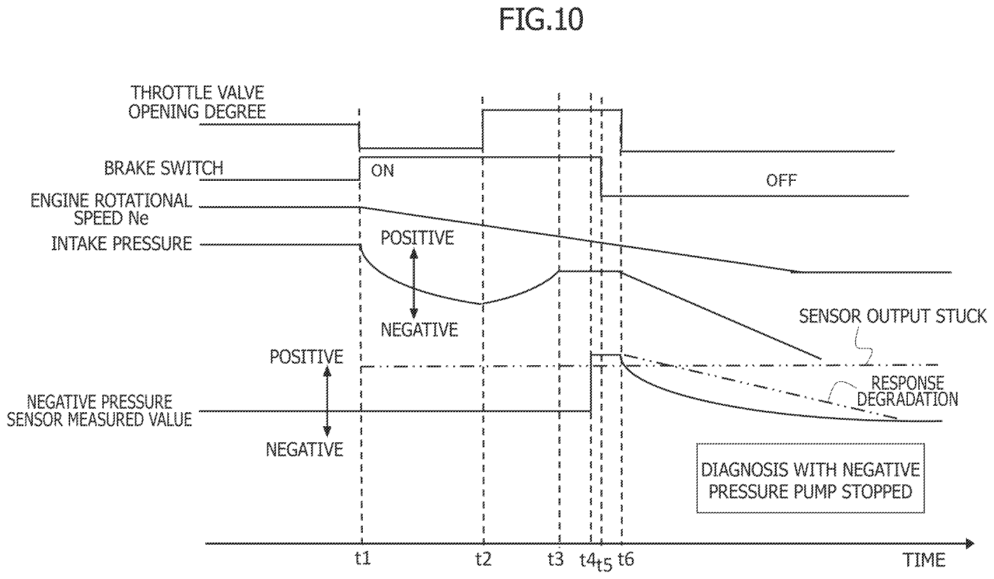

FIG. 10 illustrates an aspect of the diagnosis with the negative pressure pump stopped in the diagnosing pattern in FIG. 9.

According to the aspect of the diagnosis with the negative pressure pump stopped, illustrated in FIG. 10, the diagnosis is performed in a condition in which internal combustion engine 20 is during fuel cut and the intake negative pressure is introduced into negative pressure chamber 11.

First, brake control device 60 increases the opening degree of electronically controlled throttle 27 of internal combustion engine 20 from the fully closed state during the brake operation in the fuel cut state, as preparation for the diagnosis (monitoring the output of negative pressure sensor 71) (time t2 in FIG. 10), and brake control device 60 makes electronically controlled throttle 27 closed after releasing the brake operation (time t6 in FIG. 10).

For example, the control for increasing the opening degree of electronically controlled throttle 27 may be performed by outputting an opening degree correction request from brake control device 60 to engine control device 25, to have engine control device 25, which has received the opening degree correction request, control electronically controlled throttle 27.

Brake control device 60 increases the opening degree of electronically controlled throttle 27 during the brake operation, to increase the intake pressure toward the positive pressure side, so as to close check valve 31 (time t3 in FIG. 10), to thereby prevent the intake pressure from being introduced into negative pressure chamber 11. This makes the pressure in negative pressure chamber 11 increase toward the positive pressure side (time t2 to t5 in FIG. 10).

Thereafter, when the brake is released and electronically controlled throttle 27 is closed (time t6 in FIG. 10), the intake negative pressure develops and check valve 31 opens, so that the intake negative pressure is introduced into negative pressure chamber 11 and the pressure in negative pressure chamber 11 decreases toward the negative pressure side.

In the condition in which the pressure in negative pressure chamber 11 changes from the positive pressure side toward the negative pressure side (after time t6 in FIG. 10), brake control device 60 monitors the change in the measured pressure value obtained by negative pressure sensor 71 and determines whether there is an abnormality (degradation) of negative pressure sensor 71 based on the monitoring result.

For example, brake control device 60 obtains an amount of change in the measured pressure value obtained by negative pressure sensor 71 in a predetermined time period required since electronically controlled throttle 27 is closed (time t6 in FIG. 10) until the pressure in negative pressure chamber 11 reaches around the set pressure, and then, brake control device 60 periodically obtains a rate of change in the measure pressure value obtained by negative pressure sensor 71 in the predetermined time period.

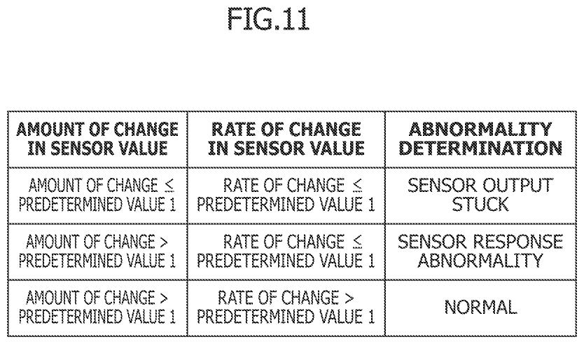

Then, brake control device 60 determines that negative pressure sensor 71 operates normally, when the amount of change in the predetermined time period exceeds a first predetermined value, and when a maximum value, an average value, or the like, of the rate of change in the predetermined time period exceeds a first predetermined rate, as illustrated in FIG. 11.

Furthermore, brake control device 60 determines that a response abnormality has occurred in negative pressure sensor 71, when the amount of change in the predetermined time period exceeds the first predetermined value, but the maximum value, the average value, or the like, of the rate of change in the predetermined time period is less than or equal to the first predetermined rate, as illustrated in FIG. 11 (step S2004 in FIG. 9).

Furthermore, brake control device 60 determines that there has been occurred an abnormality that the output of negative pressure sensor 71 does not change in response to the change in actual pressure, when the amount of change in the predetermined time period is less than or equal to the first predetermined value, and the maximum value, the average value, or the like, of the rate of change in the predetermined time period is less than or equal to the first predetermined rate in the predetermined time period (step S2004 in FIG. 9).

The rate of change is not limited to the maximum value or the average value of the rate of change in the predetermined time period. For example, brake control device 60 may use the amount of change in the measured pressure value obtained by negative pressure sensor 71 at set time T2 (T2<T1) that is immediately after electronically controlled throttle 27 is closed, as a parameter representing the rate of change.

Brake control device 60 may determine whether negative pressure sensor 71 operates normally or abnormally based on one of the amount of change and the rate of change.

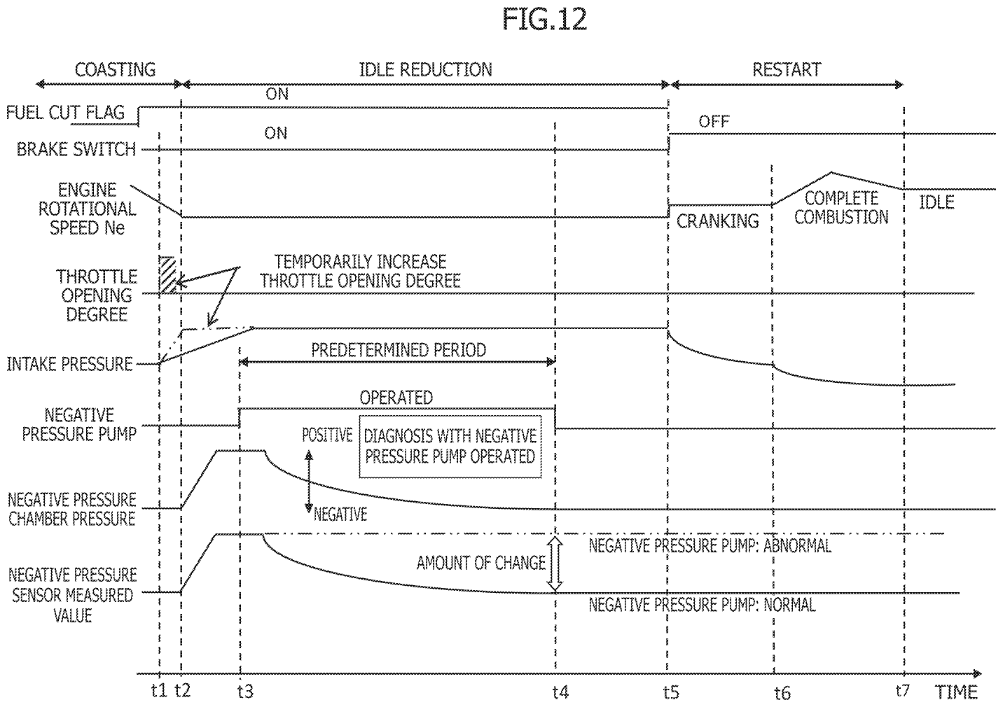

When brake control device 60 determines that negative pressure sensor 71 operates normally in the diagnosis with the negative pressure pump stopped, then brake control device 60 performs the diagnosis with the negative pressure pump operated (step S2005 in FIG. 9). FIG. 12 illustrates one aspect of the diagnosis with the negative pressure pump operated in the diagnosing pattern in FIG. 9.

According to the aspect of the diagnosis with the negative pressure pump operated, illustrated in FIG. 12, negative pressure pump 40 is operated during idle reduction of internal combustion engine 20, and brake control device 60 monitors the output of negative pressure sensor 71 in the condition in which the negative pressure generated by negative pressure pump 40 is introduced into negative pressure chamber 11.

When internal combustion engine 20 is stopped by the idle reduction function in a state in which the brake is operated (time t2 in FIG. 12), the intake pressure increases toward the positive pressure side, and the pressure in negative pressure chamber 11 also increases toward the positive pressure side. Brake control device 60 starts operating negative pressure pump 40 at the time (time t3 in FIG. 12) when a predetermined time period has elapsed from the time when internal combustion engine 20 is stopped by the idle reduction function (time t2 in FIG. 12).

Then, brake control device 60 operates negative pressure pump 40 for a predetermined time period (from time t3 to time t4 in FIG. 12), and monitors the change in output of negative pressure sensor 71 during the operated time of the negative pressure pump 40, that is, in a condition in which the pressure in negative pressure chamber 11 decreases toward the negative pressure side when negative pressure pump 40 normally operates.

Here, since it is determined that negative pressure sensor 71 operates normally, if the amount of change in the measured pressure value obtained by negative pressure sensor 71 during the operated period of negative pressure pump 40 is less than a predetermined value, brake control device 60 estimates that the pressure in negative pressure chamber 11 does not decrease because negative pressure pump 40 is not operating normally, and thus, brake control device 60 determines that negative pressure pump 40 is abnormal (step S2006 in FIG. 9).

On the other hand, if the amount of change in the measured pressure value obtained by negative pressure sensor 71 during the operated period of negative pressure pump 40 is greater than the predetermined value, brake control device 60 estimates that negative pressure pump 40 is operating normally and the pressure in negative pressure chamber 11 actually decreases, so that brake control device 60 determines that negative pressure pump 40 operates normally. Then, brake control device 60 performs the diagnosis of the brake negative pressure system (step S2007 in FIG. 9).

As illustrated in FIG. 12, if the throttle opening degree increases at a timing after fuel cut starts and before internal combustion engine 20 is stopped by idle reduction (between time t1 and time t2 in FIG. 12), the increase of the intake pressure toward the positive pressure side can be accelerated, so that the start timing of the diagnosis with the negative pressure pump operated can be advanced.

Furthermore, brake control device 60 can perform the diagnosis with the negative pressure pump operated in the condition in which the intake pressure is the positive pressure and negative pressure pump 40 makes the pressure in negative pressure chamber 11 to be negative. Thus, not only during the idle reduction, but also during supercharging by the supercharger or when the throttle is fully opened, brake control device 60 may perform the diagnosis with the negative pressure pump operated.

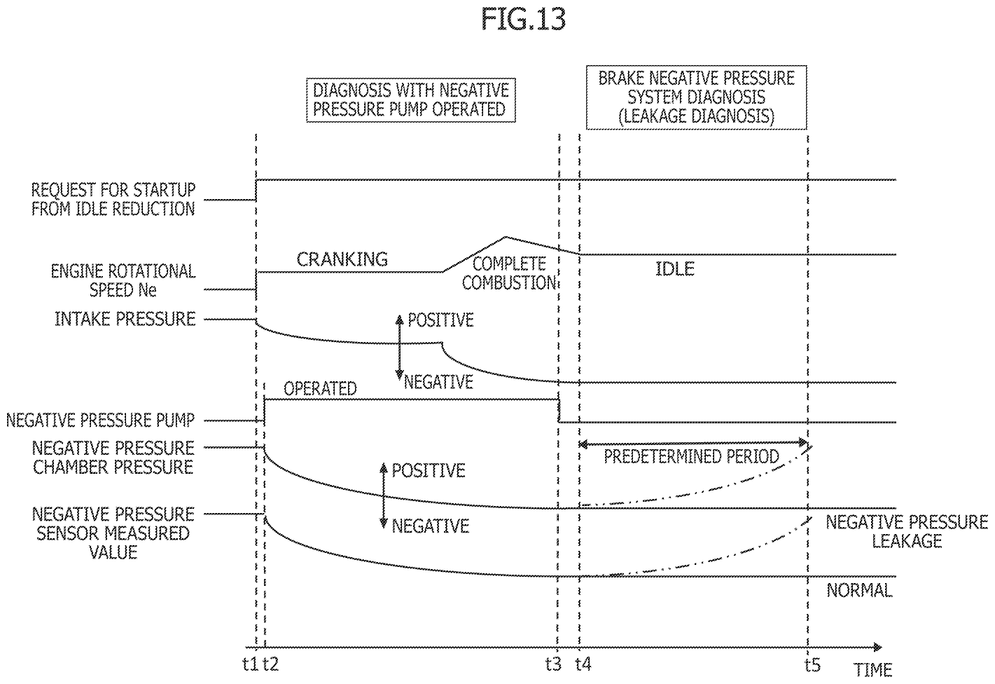

FIG. 13 illustrates one aspect of the diagnosis with the negative pressure pump operated and the diagnosis of the brake negative pressure system in the diagnosing pattern in FIG. 9.

According to the aspect of the diagnosis with the negative pressure pump operated and the diagnosis of the brake negative pressure system, illustrated in FIG. 13, the diagnoses are performed when internal combustion engine 20 is restarted from the idle reduction state, and brake control device 60 operates negative pressure pump 40 during cranking of internal combustion engine 20 and performs the diagnosis in which a decrease in pressure in negative pressure chamber 11 caused by negative pressure pump 40 is monitored, and then performs the diagnosis of the brake negative pressure system based on whether the pressure in negative pressure chamber 11, which has decreased by the operation of negative pressure pump 40 in the idle state after the complete combustion, is maintained.

When the cranking of internal combustion engine 20 starts (time t1 in FIG. 13), brake control device 60 starts operating negative pressure pump 40 (time t2 in FIG. 13), and continues operating negative pressure pump 40 until the complete combustion is achieved (time t3 in FIG. 13).

Then, brake control device 60 obtains the amount of change in the measured pressure value obtained by negative pressure sensor 71 in the operated period of negative pressure pump 40 (from time t2 to time t3 in FIG. 13).

Here, if the amount of change in the measured pressure value in the operated period of negative pressure pump 40 is greater than or equal to a predetermined value, brake control device 60 estimates that the pressure in negative pressure chamber 11 decreases as a result of normal operation of negative pressure pump 40. Thus, brake control device 60 determines that negative pressure pump 40 operates normally. Then, brake control device 60 performs the diagnosis of the brake negative pressure system (step S2007 in FIG. 9).

On the other hand, if the amount of change in the measured pressure value in the operated period of negative pressure pump 40 decreases below the predetermined value, brake control device 60 estimates that the pressure in negative pressure chamber 11 does not decrease because negative pressure pump 40 does not operate normally. Thus, brake control device 60 determines that negative pressure pump 40 is abnormal (step S2006 in FIG. 9).

When it is determined that negative pressure pump 40 operates normally in the diagnosis with the negative pressure pump operated, it is in a state in which the pressure in negative pressure chamber 11 sufficiently decreases, and brake control device 60 determines whether a negative pressure leakage from negative pressure chamber 11 has occurred based on whether the pressure in negative pressure chamber 11 is maintained in the idle state of internal combustion engine 20 which has restarted from the idle reduction state (the diagnosis of the brake negative pressure system in step S2007 in FIG. 9).

That is, brake control device 60 samples the measured pressure value obtained by negative pressure sensor 71 at the time (time t5 in FIG. 13) when a predetermined time period has elapsed from the time when internal combustion engine 20 transfers to the idle state (time t4 in FIG. 13).

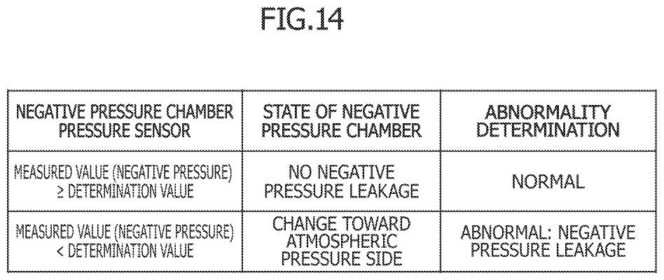

Then, if the measured pressure value at time t5 in FIG. 13 is a value on the positive pressure side with respect to the set pressure, brake control device 60 estimates that the negative pressure leaks from negative pressure chamber 11 and the pressure in negative pressure chamber 11 increases toward the positive pressure side. Thus, brake control device 60 determines that a negative pressure leakage from negative pressure chamber 11 has occurred, that is, the brake negative pressure system is abnormal, as illustrated in FIG. 14 (step S2008 in FIG. 9).

On the other hand, if the measured pressure value at time t5 in FIG. 13 is a value on the negative pressure side with respect to the set pressure, brake control device 60 estimates that the negative pressure leakage from negative pressure chamber 11 is sufficiently small and the pressure in negative pressure chamber 11 is maintained. Thus, brake control device 60 determines that there is no negative pressure leakage from negative pressure chamber 11, that is, the brake negative pressure system operates normally.

In the diagnosis of negative pressure leakage, brake control device 60 may obtain an amount of change in the measured pressure value from time t4 to time t5 in FIG. 13, and may determine whether a negative pressure leakage has occurred based on whether the amount of change decreases below a set value.

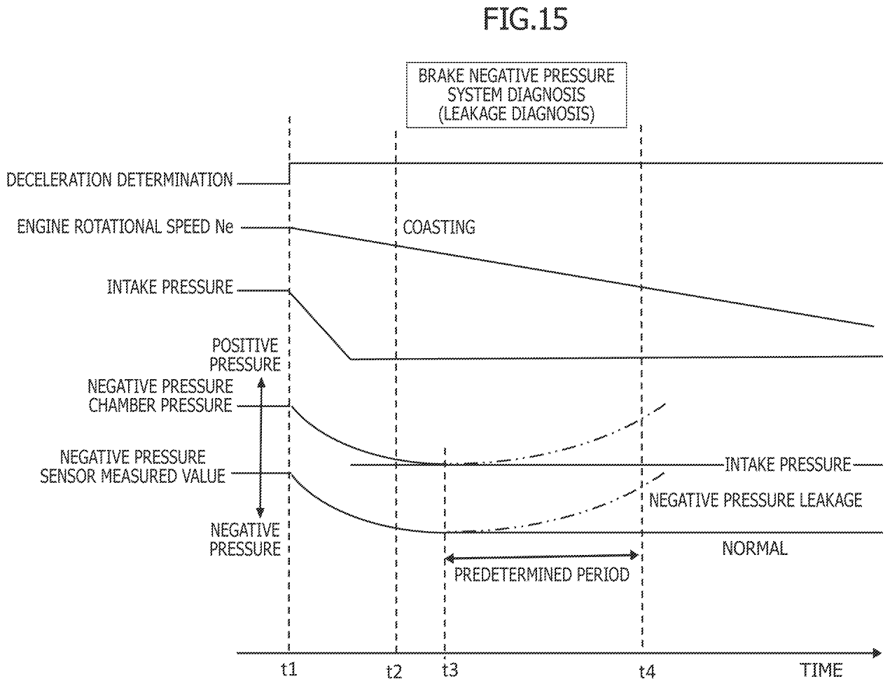

FIG. 15 illustrates one aspect of the diagnosis of the brake negative pressure system applicable to the diagnosing pattern in FIG. 9.

According to the aspect of the diagnosis of the brake negative pressure system, illustrated in FIG. 15, brake control device 60 monitors the output of negative pressure sensor 71 at the time when a predetermined time period has elapsed after the pressure in negative pressure chamber 11 reaches the set negative pressure, that is, after check valve 31 is closed, in coasting, which is a deceleration state in which the brake is not operated.

In the coasting, the intake pressure in intake manifold 21 decreases toward the negative pressure side, and the pressure in negative pressure chamber 11 into which the intake pressure is introduced also decreases, and thus, a differential pressure between the intake pressure in intake manifold 21 and the pressure in negative pressure chamber 11 becomes less. This makes check valve 31 closed (time t2 in FIG. 15), so that a negative pressure is confined in negative pressure chamber 11.

Here, if an abnormality that the negative pressure leaks from negative pressure chamber 11 has occurred, the pressure in negative pressure chamber 11 increases toward the positive pressure side. Thus, brake control device 60 determines whether the negative pressure leakage from negative pressure chamber 11 has occurred based on whether the measured pressure value obtained by negative pressure sensor 71 increases toward the positive pressure side by a predetermined amount or more in a predetermined time period (between time t3 and time t4 in FIG. 15) after the valve closing timing of check valve 31. If the measured pressure value obtained by negative pressure sensor 71 increases toward the positive pressure side by the predetermined amount or more in the predetermined time period (from time t3 to time t4 in FIG. 15), brake control device 60 determines that a negative pressure leakage from negative pressure chamber 11 has occurred, that is, the brake negative pressure system is abnormal (step S2008 in FIG. 9).

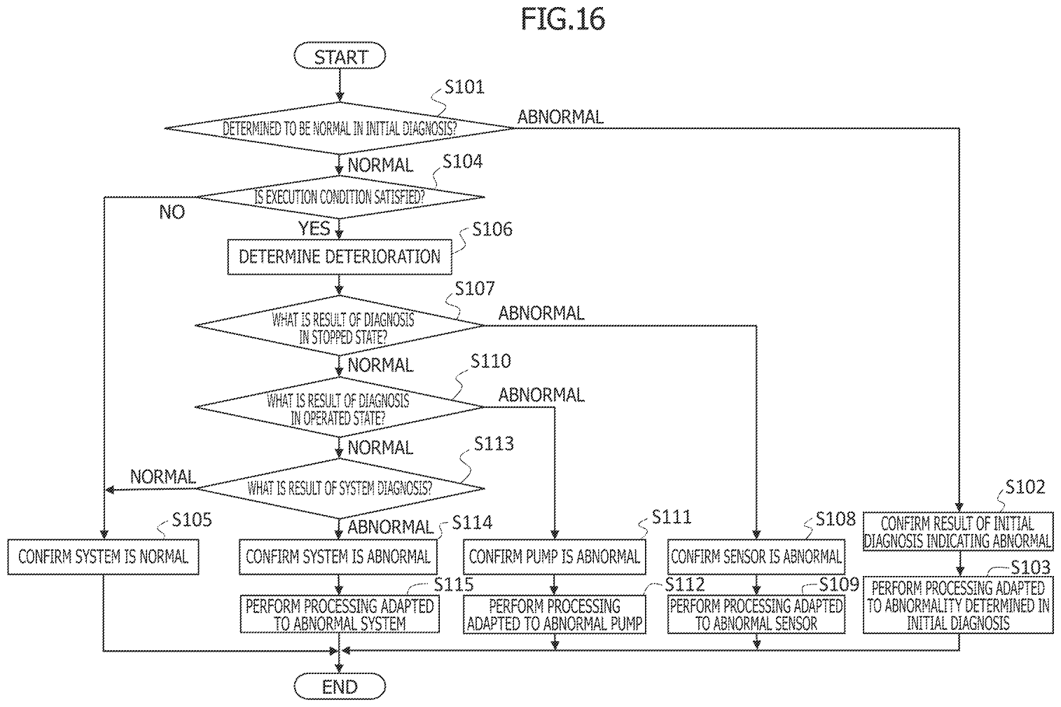

Hereinbelow, one aspect of the processing procedure of the diagnosis with the negative pressure pump operated, the diagnosis with the negative pressure pump stopped, and the diagnosis of the brake negative pressure system, in the diagnosing pattern in FIG. 9, will be described with reference to flowcharts in FIGS. 16 to 20.

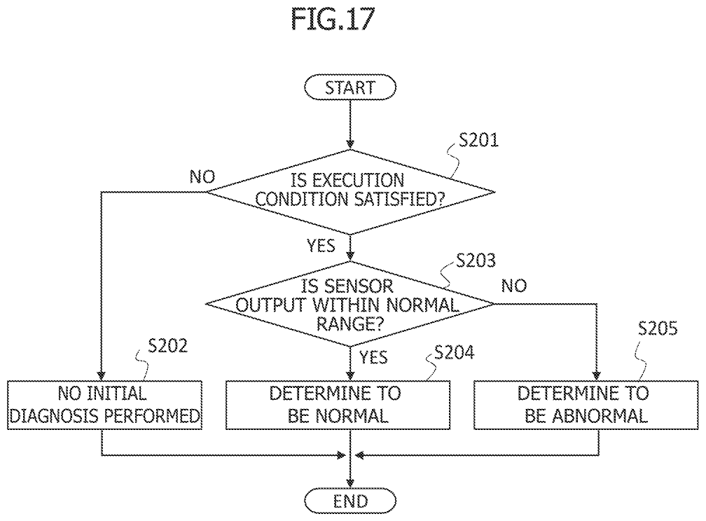

The flowchart in FIG. 16 illustrates a main routine of the diagnostic processing executed by brake control device 60, and the flowcharts in FIGS. 17 to 20 illustrate subroutines of the diagnostic processing executed by brake control device 60.

In step S101 in FIG. 16, brake control device 60 determines whether it is determined that negative pressure sensor 71 is abnormal in the initial diagnostic processing for negative pressure sensor 71.

Brake control device 60 performs the initial diagnostic processing for negative pressure sensor 71 as illustrated in the flowchart in FIG. 17.

In step S201, brake control device 60 determines whether a condition for performing the initial diagnosis is satisfied. For example, brake control device 60 may set a state in which initial processing, which is performed before startup of internal combustion engine 20, is in progress, as the execution condition of the initial diagnosis.

If the condition for performing the initial diagnosis is not satisfied, the process proceeds to step S202, and the routine is terminated without executing the initial diagnosis of negative pressure sensor 71 by brake control device 60.

On the other hand, if the condition for performing the initial diagnosis is satisfied, the process proceeds to step S203, in which brake control device 60 determines whether the output signal of negative pressure sensor 71 is within a predetermined normal range.

Then, if the output signal of negative pressure sensor 71 is within the normal range, the process proceeds to step S204, in which brake control device 60 determines that negative pressure sensor 71 operates normally as a result of the initial diagnosis of negative pressure sensor 71.

On the other hand, if the output signal of negative pressure sensor 71 is out of the normal range, the process proceeds to step S205, in which brake control device 60 determines that an abnormality has occurred in negative pressure sensor 71 as a result of the initial diagnosis of negative pressure sensor 71.

Here, the output range that corresponds to a variable range of the pressure in negative pressure chamber 11 is set in advance, as the normal range such that the output signal of negative pressure sensor 71 falls within the normal range when negative pressure sensor 71 outputs a signal corresponding to an actual pressure in negative pressure chamber 11.

If an abnormality, such as a disconnection or a short circuit in the signal line of negative pressure sensor 71, has occurred, the output signal of negative pressure sensor 71 deviates from the normal range. Thus, brake control device 60 determines that negative pressure sensor 71 is abnormal as a result of the initial diagnosis of negative pressure sensor 71.

If brake control device 60 determines that an abnormality has occurred in negative pressure sensor 71 in the initial diagnosis, the process proceeds from step S101 to step S102 in FIG. 16, and brake control device 60 confirms the determination result of the initial diagnosis of negative pressure sensor 71 indicating that the abnormality has occurred. In the next step S103, in response to the confirmation of the determination result indicating that negative pressure sensor 71 is abnormal, predetermined processing adapted to the abnormal state is performed.

For example, as the processing adapted to the abnormal state in step S103, brake control device 60 may perform processing for storing an abnormality diagnosis result as a history, processing for transmitting an abnormality diagnosis result to an external control unit, such as engine control device 25, processing for operating a warning device, such as a lamp for warning that an abnormality has occurred, and processing for limiting a maximum output torque of internal combustion engine 20 to be less than that in a normal state.

On the other hand, if the result of the initial diagnosis indicates that negative pressure sensor 71 operates normally, and there is no abnormality, such as a disconnection or a short circuit, in negative pressure sensor 71, the process of brake control device 60 proceeds to step S104 in FIG. 16.

In step S104, brake control device 60 determines whether a condition for performing a diagnosis for identifying a failed portion in booster 100 is satisfied.

For example, brake control device 60 determines that the condition for performing the diagnosis (diagnosis execution condition) is satisfied, when there is no abnormality, such as a disconnection or a short circuit, in negative pressure sensor 71 and when some abnormality (degradation) is determined in booster 100. When the diagnosis execution condition is satisfied, the process proceeds to step S106 and thereafter, in order to perform the diagnosis for identifying the failed portion.

Here, for example, brake control device 60 may determine that booster 100 is in a state in which an abnormality has occurred, when negative pressure pump 40 is continuously operated more than a reference time based on the output of negative pressure sensor 71. However, instead of using the abnormality determination as the diagnosis execution condition, brake control device 60 may set a state in which a travel distance or a driving time reaches a set value, or a state in which brake control device 60 receives a request for diagnosis from the exterior, as the diagnosis execution condition.

On the other hand, if brake control device 60 determines that the diagnosis execution condition of booster 100 is not satisfied in step S104, the process proceeds to step S105, in which brake control device 60 determines that booster 100 operates normally.

When brake control device 60 determines that the diagnosis execution condition is satisfied and the process proceeds to step S106, brake control device 60 confirms the determination result indicating that some abnormality has occurred in booster 100, and then the process proceeds to step S107.

In step S107, brake control device 60 discriminates results of a diagnosis of a function of negative pressure sensor 71.

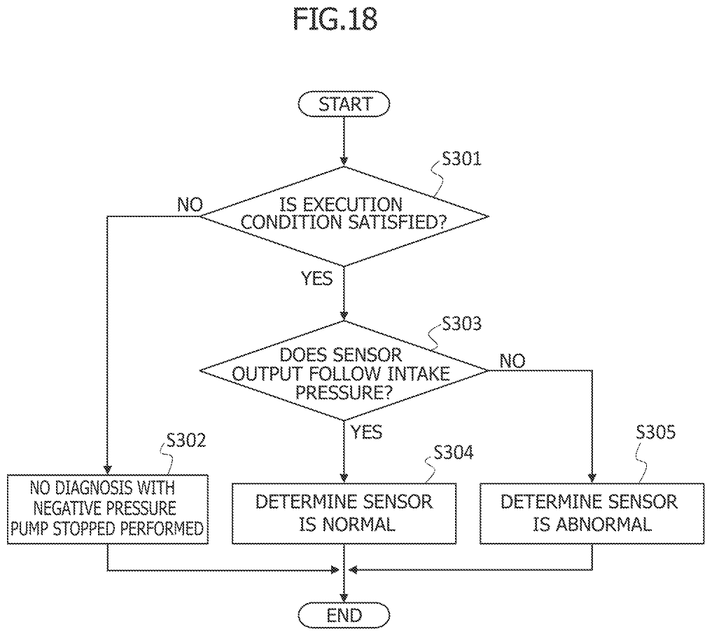

The flowchart in FIG. 18 illustrates a flow of the diagnosis of the function of negative pressure sensor 71 performed by brake control device 60.

In step S301, brake control device 60 determines whether a condition for performing the diagnosis of the function of negative pressure sensor 71, that is, the diagnosis with the negative pressure pump stopped, is satisfied.

For example, brake control device 60 may determine that the condition for performing the diagnosis of the function of negative pressure sensor 71 is satisfied, when booster 100 is in a state in which the intake negative pressure in intake manifold 21 is allowed to be introduced into negative pressure chamber 11, when the difference between the intake negative pressure and the pressure in negative pressure chamber 11 is within a predetermined range, and when the vehicle is in a deceleration operation state in which brake is not operated.

In the example of the diagnosis with the negative pressure pump stopped illustrated in FIG. 10, brake control device 60 determines that the condition for performing the diagnosis of the function of negative pressure sensor 71 is satisfied at time t6.

If brake control device 60 determines in step S301 that the condition for performing the diagnosis of the function of negative pressure sensor 71 is not satisfied, the process proceed to step S302, in which brake control device 60 sets not to perform the diagnosis of the function of negative pressure sensor 71, and then the routine is terminated.

On the other hand, if brake control device 60 determines in step S301 that the condition for performing the diagnosis of the function of negative pressure sensor 71 is satisfied, the process proceeds to step S303, in which brake control device 60 determines whether the measured pressure value obtained by negative pressure sensor 71 has decreased toward the negative pressure side in response to the change in the intake negative pressure.

Here, brake control device 60 may determine whether the measured pressure value obtained by negative pressure sensor 71 follows the actual pressure change in negative pressure chamber 11, based on the amount of change or the rate of change of the measured pressure value in a predetermined time period for monitoring the measured pressure value, as indicated in FIG. 11. Furthermore, brake control device 60 may intentionally generate a process in which the intake negative pressure develops by performing the throttle control, as indicated in FIG. 10.

Furthermore, brake control device 60 may estimate a time-series change in pressure value in negative pressure chamber 11, and compare the calculation result with the locus of the measured pressure value obtained by negative pressure sensor 71, to obtain an approximation degree, so that brake control device 60 may determine whether negative pressure sensor 71 generates an output signal corresponding to the actual pressure, based on the approximation degree.

Then, if brake control device 60 determines that the measured pressure value obtained by negative pressure sensor 71 follows the pressure change in negative pressure chamber 11, the process proceeds to step S304, in which brake control device 60 determines that negative pressure sensor 71 operates normally. If brake control device 60 determines that the measured pressure value obtained by negative pressure sensor 71 does not follow the pressure change in negative pressure chamber 11, the process proceeds to step S305, in which brake control device 60 determines that negative pressure sensor 71 is abnormal.

In step S107 in FIG. 16, brake control device 60 determines whether the result of the diagnosis of the function of negative pressure sensor 71 is normal or abnormal.

If it is determined that negative pressure sensor 71 is abnormal, the process proceeds to step S108, in which brake control device 60 confirms the determination result indicating that negative pressure sensor 71 is abnormal. In the next step S109, brake control device 60 performs predetermined processing adapted to the abnormal state in response to the determination result indicating that negative pressure sensor 71 is abnormal.

The processing adapted to the abnormal state executed in step S109 may be a similar processing to that executed in step S103. Brake control device 60 may generate abnormality diagnostic information indicating that negative pressure sensor 71 is identified as an abnormal portion, and may store the abnormality diagnostic information or output the same externally.

On the other hand, if brake control device 60 determines that negative pressure sensor 71 operates normally, the process proceeds to step S110, in which brake control device 60 discriminates results of a diagnosis of a function of negative pressure pump 40.

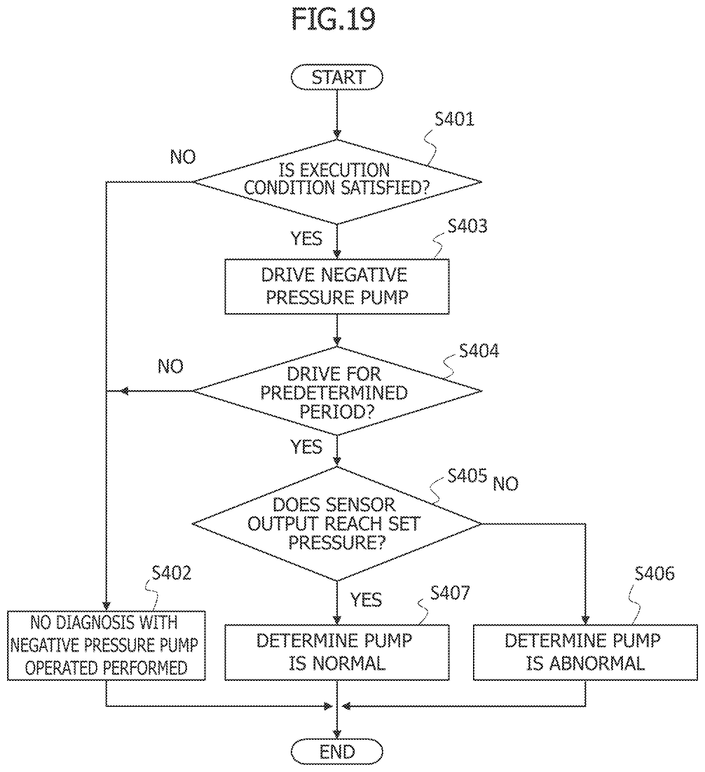

The flowchart in FIG. 19 illustrates a flow of the diagnosis of the function of negative pressure pump 40, that is, a flow of the diagnosis with the negative pressure pump operated, performed by brake control device 60.

In step S401 in FIG. 19, brake control device 60 determines whether a condition for performing the diagnosis of the function of negative pressure pump 40 is satisfied.

As the condition for performing the diagnosis of the function of negative pressure pump 40, brake control device 60 may perform the determination employing, for example, a state in which it is determined that negative pressure sensor 71 operates normally, the pressure in intake manifold 21 is positive, and the brake is not operated.

The idle reduction state of internal combustion engine 20 illustrated in FIG. 12 is an example of the operation state in which the condition for performing the diagnosis is satisfied.

If the condition for performing the diagnosis with the negative pressure pump operated is not satisfied, the process proceed to step S402, in which brake control device 60 determines not to perform the diagnosis with the negative pressure pump operated, and the routine is terminated.

On the other hand, if the condition for performing the diagnosis with the negative pressure pump operated is satisfied, the process proceeds to step S403, in which brake control device 60 operates negative pressure pump 40 for a predetermined time period (see FIG. 12).

Then, in the next step S404, brake control device 60 determines whether the operation time of negative pressure pump 40 has reached the predetermined time period. The process proceeds to step S402 until the predetermined time elapses, and the routine is terminated without determining whether negative pressure pump 40 is abnormal or normal.

When the operation time of negative pressure pump 40 has reached the predetermined time period, the process proceeds to step S405, in which brake control device 60 determines whether the pressure in negative pressure chamber 11 has reached a set negative pressure as a result of the operation of negative pressure pump 40 for the predetermined time period, based on the comparison between the measured pressure value of negative pressure sensor 71 and the set negative pressure (see FIG. 12).

Here, if the measured pressure value of negative pressure sensor 71 has not reached the set negative pressure, brake control device 60 estimates that negative pressure pump 40 is in an abnormal (degraded) state in which a desired negative pressure cannot be generated. The process proceeds to step S406, in which brake control device 60 determines that negative pressure pump 40 is abnormal (degraded).

On the other hand, if the measured pressure value of negative pressure sensor 71 has reached the set negative pressure, brake control device 60 estimates that negative pressure pump 40 is in a normal state in which the desired negative pressure is generated. The process proceeds to step S407, in which brake control device 60 determines that negative pressure pump 40 operates normally.

If brake control device 60 determines that negative pressure pump 40 is abnormal (degraded) in the diagnosis of the function of negative pressure pump 40, the process proceeds from step S110 to step S111 in FIG. 16.

In step S111, brake control device 60 confirms the determination result indicating that negative pressure pump 40 is abnormal (abnormality diagnostic information). In the next step S112, brake control device 60 performs a processing adapted to the abnormal state of negative pressure pump 40.

As the processing adapted to the abnormal state executed in step S112, brake control device 60 may execute a processing similar to those executed in steps S103 and S109. Thus, brake control device 60 may be configured to generate the abnormality diagnostic information indicating that negative pressure pump 40 is identified as an abnormal portion, to store the abnormality diagnostic information, and to output the abnormality diagnostic information externally.

On the other hand, if brake control device 60 determines that negative pressure pump 40 is in the normal state in the diagnosis of the function of negative pressure pump 40, the process proceeds from step S110 to step S113 in FIG. 16.

In step S113, brake control device 60 discriminates the result of determining whether a negative pressure leakage from negative pressure chamber 11 has occurred (result of the brake negative pressure system diagnosis).

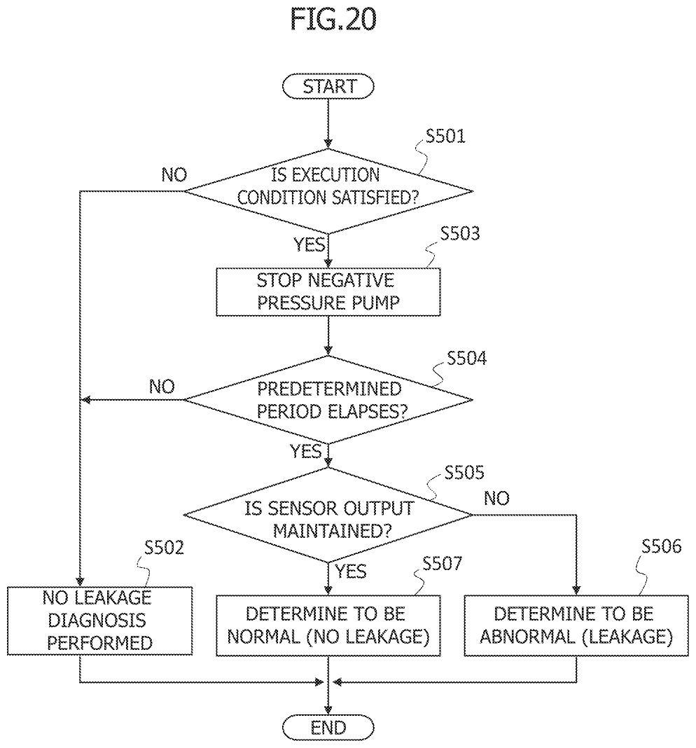

The flowchart in FIG. 20 illustrates a flow of a negative pressure leakage diagnosis (brake negative pressure system diagnosis) performed by brake control device 60.

In step S501 in FIG. 20, brake control device 60 determines whether a condition for performing the diagnosis of the brake negative pressure system, which is the negative pressure leakage diagnosis, is satisfied.

As the condition for performing the negative pressure leakage diagnosis, brake control device 60 may determine, for example, a state in which it is determined that negative pressure sensor 71 operates normally, and negative pressure pump 40 stops operating.

The coasting state, as illustrated in FIG. 15, and the idle state immediately after the diagnosis with the negative pressure pump operated, performed during cranking, as illustrated in FIG. 13, are examples of the operation state in which the diagnosis execution condition is satisfied; hereinbelow, the flow of the leakage diagnosis will be described by using, as an example, a case in which the negative pressure leakage diagnosis is performed immediately after the diagnosis with negative pressure pump 40 operated, illustrated in FIG. 13.

If the condition for performing the negative pressure leakage diagnosis is not satisfied, the process proceeds to step S502, in which brake control device 60 determines not to perform the negative pressure leakage diagnosis, and the routine is terminated.

On the other hand, if the condition for performing the negative pressure leakage diagnosis is satisfied, the process proceeds to step S503, in which brake control device 60 makes settings to stop the operation of negative pressure pump 40 based on the measured pressure value obtained by negative pressure sensor 71.

Next, in step S504, brake control device 60 determines whether a predetermined time period has elapsed from the stop of negative pressure pump 40. The process proceeds to step S502 until the predetermined time period has elapsed, to terminate the routine without determining whether a negative pressure leakage has occurred.

When the time elapsed since negative pressure pump 40 stops reaches the predetermined time period, the process proceeds to step S505, in which brake control device 60 determines whether the pressure in negative pressure chamber 11, which has reduced by negative pressure pump 40, is maintained after negative pressure pump 40 stops, based on the pressure measured by negative pressure sensor 71 at the time when the predetermined time period elapses after negative pressure pump 40 stops.

Brake control device 60 may determine whether the pressure in negative pressure chamber 11, which has reduced by negative pressure pump 40, is maintained after negative pressure pump 40 stops, based on a difference between a pressure measured by negative pressure sensor 71 at the time when negative pressure pump 40 stops and a pressure measure by negative pressure sensor 71 at the time when the predetermined time period elapses after negative pressure pump 40 stops.

That is, as illustrated in FIG. 13, when a negative pressure leakage has occurred, the pressure in negative pressure chamber 11 increases toward the positive pressure side after negative pressure pump 40 stops, that is, after the introduction of the negative pressure generated by negative pressure pump 40 stops.

Thus, when the pressure measured by negative pressure sensor 71 at the time when the predetermined time period elapses after negative pressure pump 40 stops indicates that the pressure in negative pressure chamber 11 increases toward the positive pressure side, the process proceeds to step S506, in which brake control device 60 determines that a negative pressure leakage from negative pressure chamber 11 has occurred.

Furthermore, if the pressure in negative pressure chamber 11 is substantially maintained even after the predetermined time period elapses since negative pressure pump 40 stops, the process proceeds to step S507, in which brake control device 60 determines that there is no negative pressure leakage from negative pressure chamber 11.

When brake control device 60 determines in the negative pressure leakage diagnosis that the negative pressure leakage has occurred, that is, the brake negative pressure system is abnormal, the process proceeds from step S113 to step S114 in FIG. 16.

In step S114, brake control device 60 confirms the determination result indicating that the negative pressure leakage has occurred. In the next step S115, brake control device 60 performs processing adapted to the abnormal state, that is, the negative pressure leakage.

As the processing adapted to the abnormal state in step S114, brake control device 60 may perform processing similar to those executed in steps S103, S109, and S112. Thus, brake control device 60 may be configured to generate the abnormality diagnostic information indicating that the negative pressure leakage from negative pressure chamber 11 is identified as the abnormality, and to store the abnormality diagnostic information, and to output the abnormality diagnostic information externally.

Furthermore, as the processing adapted to the abnormal state performed in step S114 when the negative pressure leakage has occurred, brake control device 60 may change the condition for operating negative pressure pump 40, or may increase a voltage applied to negative pressure pump 40, for example.

Here, for example, changing the condition for operating negative pressure pump 40 may be achieved by changing a pressure threshold used when on and off of negative pressure pump 40 are switched based on the comparison between the measured pressure value of negative pressure sensor 71 and the pressure threshold. When the negative pressure leakage has occurred, the pressure threshold may be changed to increase the opportunity for operating negative pressure pump 40.

Furthermore, in the negative pressure leakage diagnosis, brake control device 60 may be configured to obtain an amount of change in pressure toward the positive pressure side after the pressure in negative pressure chamber 11 reaches the set negative pressure, to determine the level of negative pressure leakage, to perform processing adapted to the abnormal state, which processing differs depending on the level of the negative pressure leakage.

When it is determined that there is no negative pressure leakage from negative pressure chamber 11 in the negative pressure leakage diagnosis, the process proceeds from step S113 to step S105 in FIG. 16, in which brake control device 60 determines that negative pressure sensor 71 and negative pressure pump 40 are normal, and there is no negative pressure leakage from negative pressure chamber 11.

Thus, it is possible for the abovementioned diagnostic processing to determine whether the cause of abnormality is an abnormality in negative pressure sensor 71, an abnormality in negative pressure pump 40, or an abnormality in the brake negative pressure system, when some abnormality has occurred in booster 100 and accordingly the initial performance cannot be exhibited.

Thus, when some abnormality occurs in booster 100, it is possible for an operator of maintenance to recognize where the abnormal portion is, and it is possible to perform maintenance of the identified abnormal portion. Thus, it is possible to avoid unnecessary maintenance, such as replacement of a normal portion, resulting in increased work efficiency of vehicle maintenance.

Furthermore, since the abnormal portion is identified, it is possible for brake control device 60 to perform the processing adapted to the abnormal state suitable for the abnormal portion.

The contents of the invention have been described in detail above with reference to the preferred embodiments, but it is apparent that one skilled in the art can make various types of modifications based on the basic technical concept and teachings of the invention.

For example, brake control device 60 may perform the initial sensor diagnosis, the diagnosis with the negative pressure pump operated, the diagnosis with the negative pressure pump stopped, and the diagnosis of the brake negative pressure system (negative pressure leakage diagnosis), from the power-on to the complete combustion of internal combustion engine 20, and brake control device 60 may also perform the diagnosis with the negative pressure pump operated, the diagnosis with the negative pressure pump stopped, the diagnosis of the brake negative pressure system, during travelling of the vehicle.

Furthermore, brake control device 60 may perform any one of the diagnoses selected from the diagnosis with the negative pressure pump operated, the diagnosis with the negative pressure pump stopped, and the diagnosis of the brake negative pressure system, based on an external diagnosis request signal.

Furthermore, in a device provided with an electronic control device having a function serving as brake control device 60 and a function serving as engine control device 25, the electronic control device may perform the diagnostic processing of booster 100.

### REFERENCE SYMBOL LIST

10 Vacuum servo
11 Negative pressure chamber
20 Internal combustion engine
21 Intake manifold
25 Engine control device
31 Check valve
40 Negative pressure pump
60 Brake control device
71 Negative pressure sensor
72 Intake pressure sensor
100 Booster

1. An abnormality diagnostic device for a booster including: a negative pressure pump that generates a negative pressure; a negative pressure chamber into which the negative pressure generated by the negative pressure pump and an intake pipe negative pressure of an internal combustion engine are introduced; and a pressure sensor that measures a pressure in the negative pressure chamber, the booster boosting a brake operating force by a negative pressure in the negative pressure chamber,
the abnormality diagnostic device comprising:
a first determining unit configured to determine a change in a measured pressure value obtained by the pressure sensor, in a state in which the negative pressure pump is stopped;
a second determining unit configured to determine a change in a measured pressure value obtained by the pressure sensor, in a state in which the negative pressure pump is operated; and
a diagnosing unit configured to receive a determination result of the first determining unit and a determination result of the second determining unit, to generate abnormality diagnostic information for each of the negative pressure pump and the pressure sensor.

2. The abnormality diagnostic device for the booster, according to claim 1,
wherein the first determining unit is configured to determine the change in the measured pressure value obtained by the pressure sensor, in the state in which the negative pressure pump is stopped and in a condition in which the pressure in the negative pressure chamber decreases due to the intake pipe negative pressure of the internal combustion engine,
wherein the second determining unit is configured to determine the change in the measured pressure value obtained by the pressure sensor in the state in which the negative pressure pump is operated and in a condition in which the pressure in the negative pressure chamber decreases due to the negative pressure generated by the negative pressure pump.

3. The abnormality diagnostic device for the booster, according to claim 2, wherein the diagnosing unit generates abnormality diagnostic information indicating that there is an abnormality in the pressure sensor, when an amount of change in the measured pressure value obtained by the pressure sensor in a predetermined time period determined by the first determining unit is less than a threshold.

4. The abnormality diagnostic device for the booster, according to claim 2, wherein the diagnosing unit:
generates abnormality diagnostic information indicating that the pressure sensor operates normally, when an amount of change in the measured pressure value obtained by the pressure sensor in a predetermined time period determined by the first determining unit is greater than a first threshold; and
generates abnormality diagnostic information indicating that there is an abnormality in the negative pressure pump, when an amount of change in the measured pressure value obtained by the pressure sensor in a predetermined time period determined by the second determining unit is less than a second threshold, on the condition that it is determined that the pressure sensor operates normally.

5. The abnormality diagnostic device for the booster, according to claim 2,
wherein the second determining unit is configured to determine the change in the measured pressure value obtained by the pressure sensor, in the state in which the negative pressure pump is operated, before completion of startup of the internal combustion engine,
wherein the first determining unit is configured to determine the change in the measured pressure value obtained by the pressure sensor, in the state in which the negative pressure pump is stopped, in a first idle state after the completion of startup of the internal combustion engine,
wherein the diagnosing unit:
generates abnormality diagnostic information indicating that the negative pressure pump operates normally and abnormality diagnostic information indicating that the pressure sensor operates normally, when an amount of change in the measured pressure value obtained by the pressure sensor in a predetermined time period determined by the second determining unit is greater than a first threshold; and
in a case in which the amount of change in the measured pressure value obtained by the pressure sensor in the predetermined time period determined by the second determining unit is less than the first threshold, generates abnormality diagnostic information indicating that there is an abnormality in the pressure sensor, when an amount of change in the measured pressure value obtained by the pressure sensor in a predetermined time period determined by the first determining unit is less than a second threshold, whereas generates abnormality diagnostic information indicating that there is an abnormality in the negative pressure pump, when the amount of change in the measured pressure value obtained by the pressure sensor in the predetermined time period determined by the first determining unit is greater than the second threshold.

6. The abnormality diagnostic device for the booster, according to claim 2, wherein the diagnosing unit determines whether there is an abnormality in the negative pressure pump based on an amount of change in the measured pressure value obtained by the pressure sensor in a predetermined time period determined by the second determining unit, on the condition that the diagnosing unit has generated abnormality diagnostic information indicating that the pressure sensor operates normally based on an amount of change in the measured pressure value obtained by the pressure sensor in a predetermined time period determined by the first determining unit.

7. The abnormality diagnostic device for the booster, according to claim 2, further comprising a third determining unit configured to determine a change in a measured pressure value obtained by the pressure sensor in a condition in which the pressure in the negative pressure chamber is maintained at a predetermined negative pressure,
wherein the diagnosing unit:
receives a determination result of the third determining unit; and
on the condition that the diagnosing unit has generated abnormality diagnostic information indicating that the pressure sensor operates normally and has generated abnormality diagnostic information indicating that the negative pressure pump operates normally, generates abnormality diagnostic information indicating that a negative pressure leakage has occurred in the negative pressure chamber, when the measure pressure value obtained by the pressure sensor determined by the third determining unit increases above a set pressure.

8. The abnormality diagnostic device for the booster, according to claim 2, wherein at least one of the first determining unit and the second determining unit determines a change in measure pressure value obtained by the pressure sensor, after the pressure in the negative pressure chamber increases toward a positive pressure side.

9. An abnormality diagnostic method for a booster including: a negative pressure pump that generates a negative pressure; a negative pressure chamber into which the negative pressure generated by the negative pressure pump and an intake pipe negative pressure of an internal combustion engine are introduced; and a pressure sensor that measures a pressure in the negative pressure chamber, the booster boosting a brake operating force by a negative pressure in the negative pressure chamber,
the abnormality diagnostic method comprising:
a first step of determine a change in a measured pressure value obtained by the pressure sensor, in a state in which the negative pressure pump is stopped and in a condition in which the pressure in the negative pressure chamber decreases due to the intake pipe negative pressure of the internal combustion engine;
a second step of determining a change in a measured pressure value obtained by the pressure sensor, in a state in which the negative pressure pump is operated and in a condition in which the pressure in the negative pressure chamber decreases due to the negative pressure generated by the negative pressure pump; and
a third step of receiving the change in the measured pressure value determined in the first step and the change in the measure pressure value determined in the second step, to generate abnormality diagnostic information for each of the negative pressure pump and the pressure sensor.
